(19) United States
(12) Patent Application Publication
(10) Pub. No.: US 2008/0133678 A1
(43) Pub. Date: Jun. 5, 2008

(54) Content sharing system and method for devices

(75) Inventors: Braxton Woodham, Los Angeles, CA (US); Harry Evans, Los Angeles, CA (US)

Correspondence Address: DLA PIPER US LLP, 2000 UNIVERSITY AVENUE, E. PALO ALTO, CA, 94303-2248, US

(73) Assignee: Zannel, Inc.

(21) Appl. No.: 11/607,359

(22) Filed: Dec. 1, 2006

(51) Int. Cl. G06F 15/16

(52) U.S. Cl. 709/206

(57) ABSTRACT

A content sharing system and method are provided wherein the system may include a pass-it-on feature wherein the content is wrapped in an application so that the content can be more easily shared among users of heterogeneous connected devices.

### FIELD OF THE INVENTION

The invention relates to a system and method for sharing content between devices.

### BACKGROUND OF THE INVENTION

Many systems exist that permit a user to share content with other users, such as many of the presently existing social networking systems. Most of the systems require that the user has some particular application (that the user may not have available on the mobile device being used by the user) in order to view and interact with the content. In addition, these systems do not provide a simple mechanism to share the content and create viral tracking of the content. It is desirable to provide a system that is able to provide these elements and thus it is desirable to provide a content sharing system and method for computing devices and it is to this end that the present invention is directed.

### BRIEF DESCRIPTION OF THE DRAWINGS

FIG. 1 illustrates an example of an implementation of a content sharing system for computing devices;

FIG. 2 illustrates a pass it on message process for a new user of the content sharing system;

FIG. 3 illustrates a pass it on message received process that illustrates how the receiving computing device handles the message from the sending computing device;

FIG. 4 illustrates a pass it on application install process;

FIG. 5 illustrates a pass it on method when both the sender and receiver are content sharing system users;

FIG. 6 illustrates an example of the pass-it-on process;

FIG. 7 illustrates an example of the pass it on application user interface on the sender and receiver side;

FIG. 8 illustrates an example of the user interface at the pass it on sender device during the sending of content; and

FIG. 9 illustrates an example of the user interface at the pass it on receiver device during receiving of content.

### DETAILED DESCRIPTION OF AN EMBODIMENT

For illustration purposes, the system and method are described in the context of a content sharing system for a mobile phone with the particular implementation shown in the figures and it is in this context that the system and method will be described. It will be appreciated, however, that the system and method has greater utility since the system and method may be implemented using other system and computer architectures and may be used for sharing content with a plurality of different computing devices, including wireless email devices, PDAs, portable music devices and other computing devices with sufficient processing power, memory and connectivity such that they can receive and share content using the system. In addition, the embodiment below is being used to share content which is an image. However, the content sharing system may also be used to share other content, such as games or video and video clips.

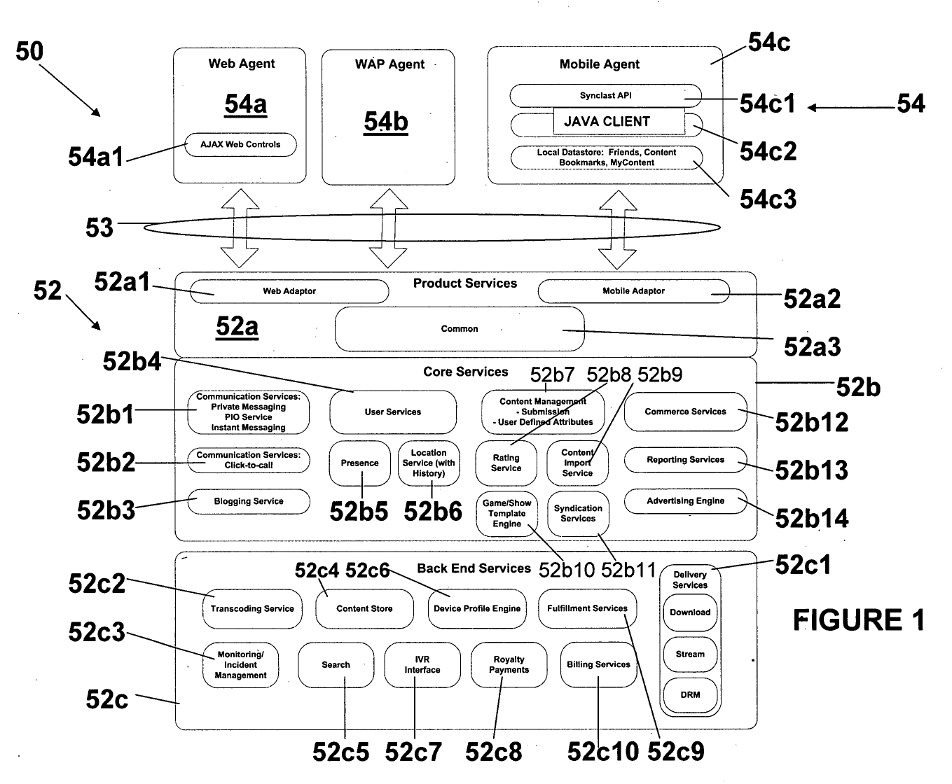

FIG. 1 illustrates an example of an implementation of a content sharing system 50 for mobile devices wherein the system has a particular illustrative architecture shown in FIG. 1. It should be understood, however, that the system is not limited to the particular architecture shown in FIG. 1 and those other variations are well known to one of ordinary skill in the art. The system may include a content sharing unit 52 that is coupled over a link 53 to one or more mobile agents 54 that provide an interface to deliver messages to one or more different types of computing devices. The messages may be delivered to a client on the computing device resident or in communications with the one or more computing devices so that the one or more mobile devices are able to share content using the content sharing unit and the functions and operations of the content sharing unit. In an exemplary implementation, the content sharing unit 52 may be one or more typical server computers that host the services described below wherein the server computer(s) execute one or more pieces of code (having a plurality of lines of computer code) wherein the execution of the lines of computer code implements the services/functions and operations of the content sharing unit. In the exemplary implementation, the link 53 is the Internet that uses typical protocols (HTTP or HTTPS) to permit each mobile device 54 to create a session with the content sharing unit wherein the content sharing unit and mobile devices are able to exchange information and data with each other over the link. Each mobile device may be a processing unit based device that has sufficient memory and connectivity in order to interact with the content sharing unit. In the exemplary implementation, the mobile devices may be a mobile phone, a cellular phone, a wireless email device, a combined email/phone device, a web browser application on the mobile device, a PDA and the like. Each of the agents are interfaces to different types of mobile devices/protocols that can be used to access the content on the site.

The content sharing unit 52 may further include a product services unit 52a, a core services unit 52b and a back end services unit 52c wherein the product services provide the content and application of the content sharing unit to the agents 54, the core services unit performs the core operations and functions of the content sharing system as is described in more detail below and the back end services unit performs the backend services of the content sharing system as is described in more detail below. The product services unit 52a may include a web adaptor 52a1 that adapts the content of the content sharing system for a web-based device, a mobile adaptor 52a2 that adapts the content of the content sharing system for a mobile device and a common element 52a3 that formats and prepares the content of the content sharing system for both of the web devices and mobile devices. For example, mobile clients (using WAP or the mobile client) will see smaller chunks of content due to the smaller screen size of these mobile clients. The core services unit 52b may include a communications services unit 52b1 that provides private messaging services, instant messaging and a pass-it-on (PIO) service that is described in more detail below, a click-to-call service 52b2 that permits a user to click on a link/button and call another user over the well known voice over IP technology and a blogging service 52b3 that permits the users of the system to create well known blogs. The core services unit 52b may further include a user service 52b4 that provides various services to the user and manages the user profile information including the computing devices and types of computing devices associated with the user, a presence service 52b5 that determines, stores and tracks the presence of each user that may be used for the viral tracking function described below, and a location service 52b6 that determines, stores and tracks the history of each user of the system that may also be used for the viral tracking function. The core services unit 52b may further include a content management service 52b7 that manages the submissions of the user, the user defined attributes of the content and the content attributes that support mapping to the computing device families, a rating service 52b8 that provides the function of rating the content associated with the system, a content import service 52b9 that manages the importing of content into the system en masse, a game/show template engine 52b 10 that provides game/show functionality to each user of the system and a syndication service 52b11 that provides syndication functions for the content sharing system. The core services unit 52b may further include a commerce service 52b12 that provides various ecommerce functions for the content sharing system, a reporting service 52b 13 that provides various reporting functions of the content sharing system and an advertising engine 52b14 that permits the content sharing system to provide advertisements to the users of the system.

The back end services unit 52c may further include a delivery services unit 52c1 that provides content delivery services of the content sharing system including downloads, streaming content and digital rights management functions, and a transcoding service 52c2 that encodes and decodes the content for each different type of mobile device, a monitoring and incident management unit 52c3 and a content store 52c4 that stores the plurality of pieces of content that are shared using the content sharing system. The back end services unit 52c may further include a search unit 52c5 that permits users of the system to perform various different searches for content and associated users, a device profile engine 52c6 that determines and stores the profile for each different computing device so that the content files can be associated with each computing device based on the device profile and content attributes, an integrated voice response (IVR) interface 52c7, a royalty payments unit 52c8 that manages royalty payments of the content in the system, a fulfillment service 52c9 that manages all transactions associated with content access and consumption and a billing service 52c 10 for billing functions of the content sharing system.

The agents 54 are the interfaces to the functionality that permits a user of the system to share and access content by one or more different methods. For example, the agents may include a web agent 54a that provides an interface to deliver the content (in the application wrapper as described below) for web-based devices or to a web page that is served to a user or a WAP agent 54b that provides the interface to deliver the content and application wrapper to a WAP-enabled device. The agents may also include a mobile agent 54c that is an interface that delivers the content to the various different computing devices that interact with the system. The web agent 54a may further include AJAX web controls 54a1 that permit the user of this web-based content to interact with the content delivered by the system. The mobile agent 54c may further include a synclast API 54c1 which is well known and disclosed at http://sourceforge.net/projects/synclast/, a JAVA client 54c2 and a local datastore 54c3 that stores local information about the friends, content bookmarks and local content of the user of the mobile device.

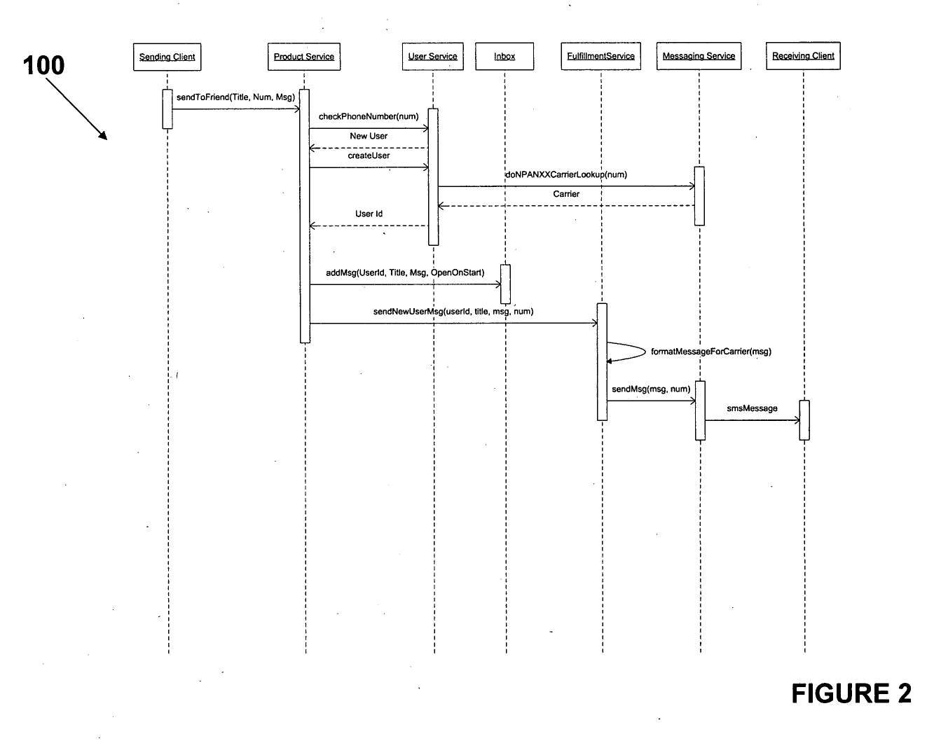

FIG. 2 illustrates a pass it on method 100 that includes a sending client (who passes a piece of content onto a friend), a product service shown in FIG. 1, a user service shown in FIG. 1, an inbox, a fulfillment service shown in FIG. 1, a messaging service shown in FIG. 1 and a receiving client that receives the pass it on message. In the method, a sending client (a user of the system shown in FIG. 1) generates a sendToFriend (Title, Num,Msg) message that includes the title of the content, the mobile address (phone number) of the receiving client and a personal message to accompany the content. In the method shown in FIG. 2, the user of the receiving client is not a user of the content sharing system. Therefore, the message is communicated to the product service that checks the phone number of the receiving client (checkPhoneNumber(num)) with the user service and, if it is a new user, sends a message back so that the product service creates a new user (createUser). If the receiving client is a user or has now become a new user, the user service performs a carrier lookup process with the messaging service (doNPANXXCarrierLookup(num) to look up the carrier for the receiving client and the messaging service returns the carrier to the user service. In an exemplary embodiment, the carrier lookup is performed by a third party aggregator who provides the carrier information to the messaging service of the content sharing system. The user service then returns the User Id of the receiving client to the product service. The product service then performs an add message process (addMsg(UserId, Title, Msg, OpenOnStart) which adds the message with a reference to the content into the inbox associated with the receiving client. The product service then sends the message (sendNewUserMsg(userId, title, msg, num)) to the fulfillment service that formats the message for the particular identified carrier (formatMessageForCarrier(msg)) and the fulfillment service sends the formatted message (sendMsg(msg,num)) onto the messaging service which then forwards the message (as an SMS message in the example shown in FIG. 2) onto the receiving client. This message lists the user name of the sender, contains a personal message from the sender, and encourages the receiver to access the message and content on the system by clicking an embedded link and launching the computing device browser.

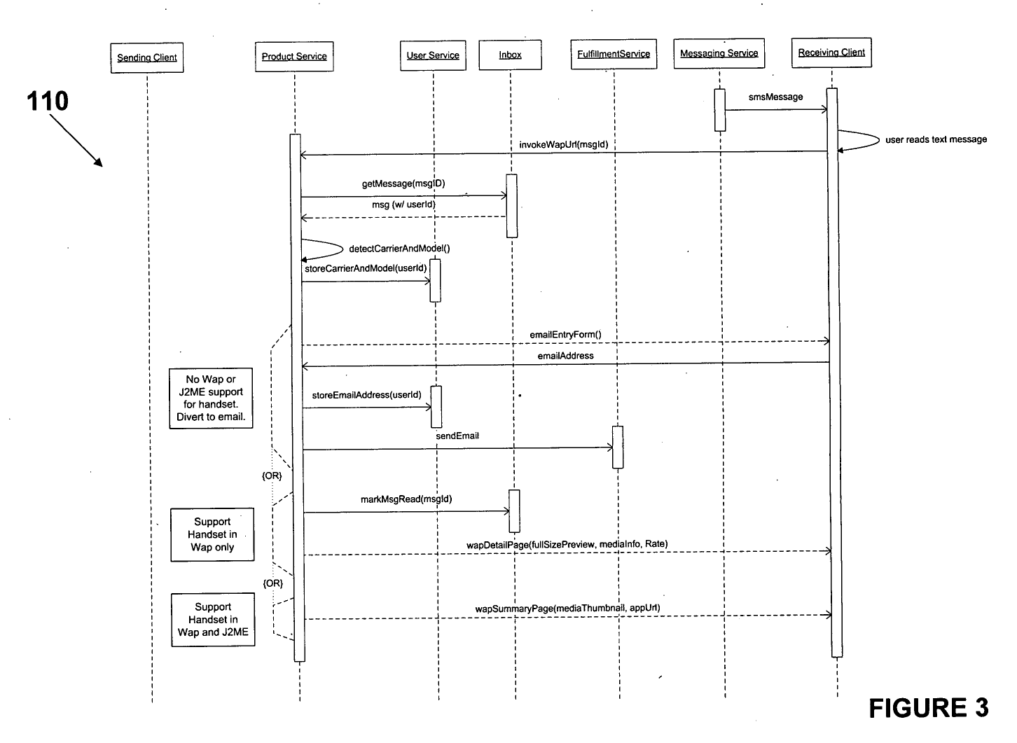

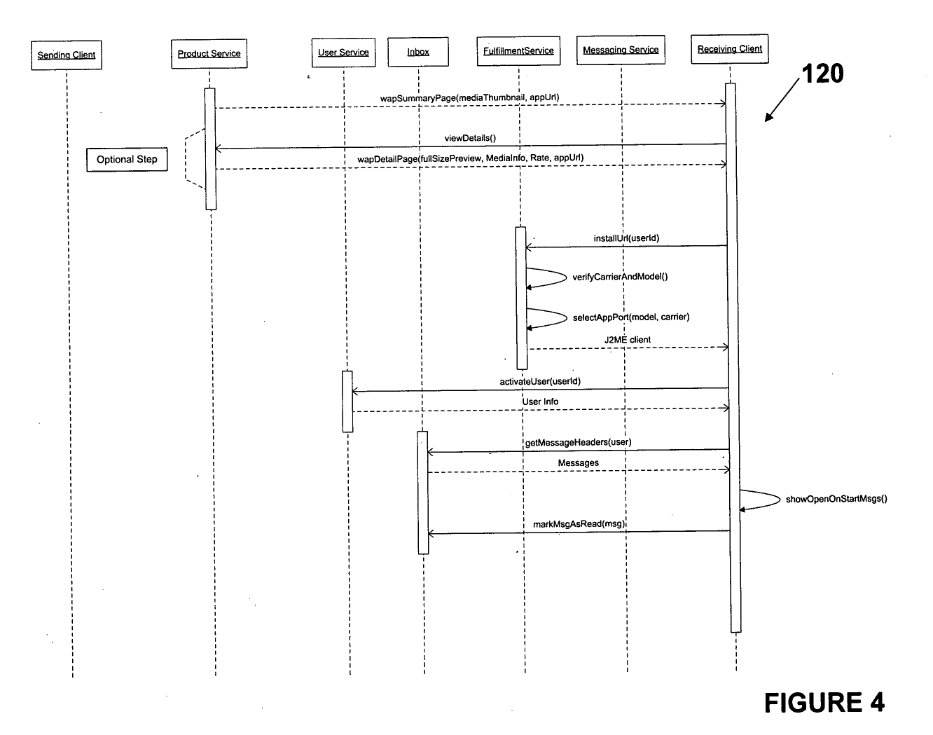

FIG. 3 illustrates a process 110 wherein the messaging service sends a formatted message, such as an SMS message, to a new user (the receiving client) and the user reads the text message. The text message contains the user name of the sender, a personal message from the sender and a URL. When the receiving user reads the text message and invokes the URL, the product service calls (invokeWap(msgId). The product service retrieves the message from the inbox of the sending user (getMessage(msgID)) and the message is returned to the product service. The product service then detects the carrier and model from the UAProf header on the WAP request and then stores that information for the user in the user service (storeCarrierAndModel(userId)). The next steps of this process depend on the capabilities of the computing device that is the receiving client. The information about the capabilities of the computing device is known from the above carrier and model detection step. The process may include a set of steps when the computing device has no WAP or mobile application (J2ME in this example) support so that the messages must be delivered by email and those steps are shown in FIG. 4. The process may also include a set of steps when the computing device supports WAP only in which case a WAP message (wapDetailPage(fullSizePreview, mediainfo,Rate) is delivered to the receiving client. If the computing device that is executing the receiving client supports both WAP and J2ME, then the product service sends a custom WAP summary page (wapSummaryPage(mediaThumbnail, appUrl) to the receiving client that contains an embedded link to download a specific version of the mobile application that is formatted for the receiving user's computing device. Using the process, the pass it on method is able to deliver a message to any computing device regardless of the capabilities of the computing device.

FIG. 4 illustrates a pass it on application install process 120 in which the application wrapper for the content is installed on the receiving client. In the method, the product service generates a summary page (wapSummaryPage(media Thumbnail, appUrl) that is sent to the receiving client wherein the summary page has a thumbnail of the piece of content/media. The receiving client may optionally request further details from the product service (viewDetails( )) and the product service sends back a details page (wapDetailPage(fullSizePreview, Mediainfo, Rate, AppUrl)) that contains the a full size preview of the media/content, information about the media/content, the price of the media/content (if applicable) and the URL for the application wrapper for the content/media. The receiving client, when the user of the receiving client clicks on the content/media, performs an install operation (InstallUrl(userId)) of the application by sending a message to the fulfillment service. The fulfillment service, in response to this install request, verifies the carrier (verifyCarrierAndModel) and the model of the computing device on which the receiving client operates, selects the appropriate application for that carrier and model (selectAppPort(model, carrier)) and then sends the client (J2ME client is this example) to the receiving client. The receiving client, once it receives, installs and launches the application, performs an activate user process with the user service (activateUser(userId)) wherein the user information is sent back to the receiving client. The receiving client then gets the message header (getMessageHeaders(user)) and the messages are returned from the inbox of the receiving client user to the receiving client. The receiving client may then show the messages to open when the application is started (showOpenOnStartMsgs( )) and the messages are marked as read in the inbox as they are opened and viewed by the receiving client user.

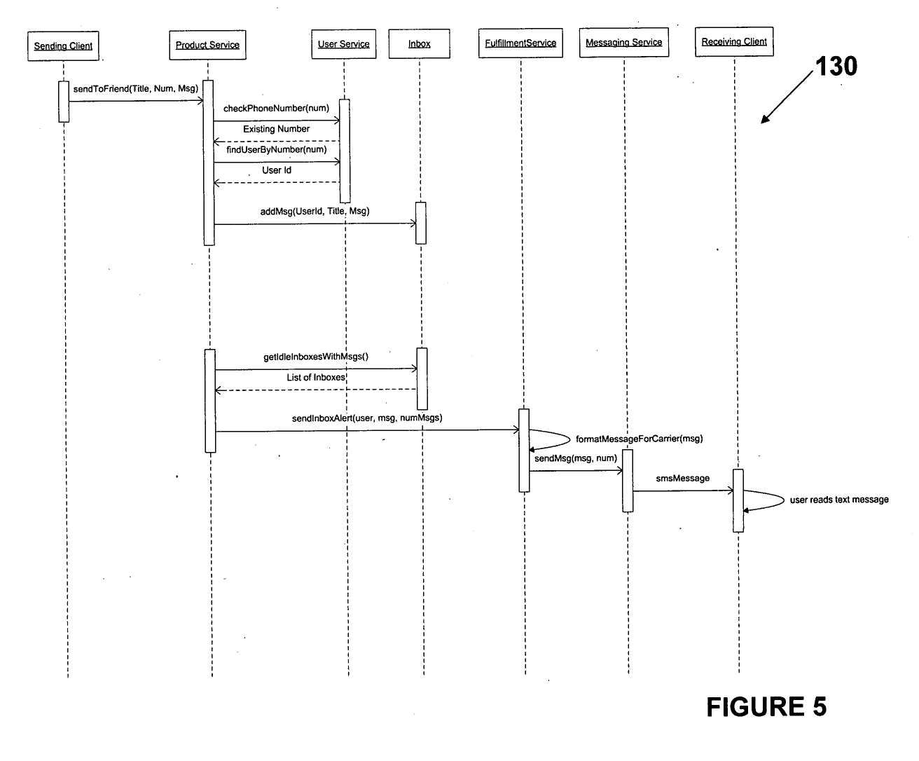

FIG. 5 illustrates a pass it on message process 130 wherein the sending client sends a message to a friend who is an existing user of the system using the system (sendToFriend(Title,Num,Msg) and the product service. The product service then checks the phone number of the friend (checkPhoneNumber(num)) and has a validation from the user service that the number exists. The product service may then locate the user by the phone number (findUserByNumber(num)) and the User Id is returned by the user service. Using the User Id, the product service generates a new message (addMsg(UserId,Title,Msg) that contains the title of the content and the original message from the sending client and places it into the inbox of the receiving client user. If the user of the receiving client retrieves that message then this process is completed. The product service periodically polls the inboxes to ensure that all messages are being picked up by the users. Thus, the product service retrieves any idle inboxes that contain messages (getIdleInboxes With Msgs( )) that have not been viewed by the user for a threshold period of time, and receives a list of those idle inboxes from the system. The product service sends an inbox alert (sendInboxAlert(user.msg, numMsgs) to each user who has not picked up the message in the inbox wherein the alert is sent to the fulfillment service that formats the alert for the appropriate carrier being used by the computing device of the receiving client and then sends the alert through the messaging service (as a formatted message such as an SMS message or an email message) to the receiving client that reads the alert as a text message.

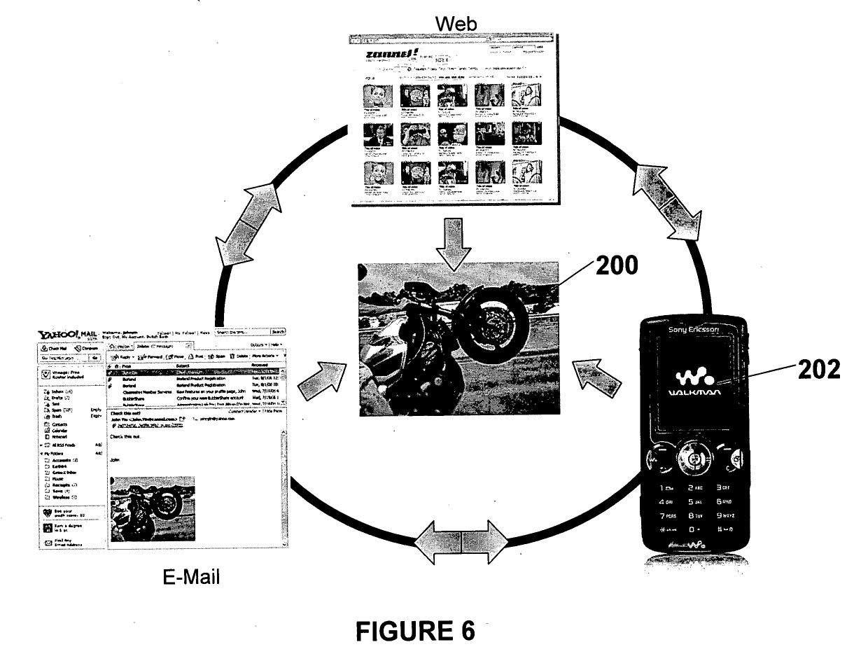

FIG. 6 illustrates an example of the pass it on process. In particular, a piece of content 200, which is a photo, can be shared between users that are part of the content sharing system using the pass it on process. As shown in FIG. 6, the content may be embedded into a message (such as an email message), it may be part of a gallery shown to the user over a web interface and/or it may be shared with a computing device 202 as described above wherein the system operates with various different computing devices that have different capabilities including different screen sizes, different protocol support (WAP, J2ME and/or neither) and other different capabilities. The system is able to install an agent on each different type of computing device so that each computing device is able to participate in the sharing of content using the system.

The system permits multiple different computing devices 202 to establish a session or path (an email, a WAP page or the Java client) with the system and then share content using the system. The system supports various different types of computing devices wherein the computing device must have sufficient processing power, memory and connectivity to establish a session with and interact with the unit 52. The system, as described above, is able to adjust its delivery of content for the different capabilities of the computing device. For example, the computing device may be a mobile phone (of various sorts with different capabilities), a laptop computer, a PDA, a Windows CE based device, a wireless email device and the like. In fact, the system described herein is not limited to any particular computing device since the system is able to deliver/share content with any computing device that has certain minimal requirements. Now, examples of the pass it on application user interface, the pass it on sender device user interface and the pass it on receiver device user interface are described in more detail.

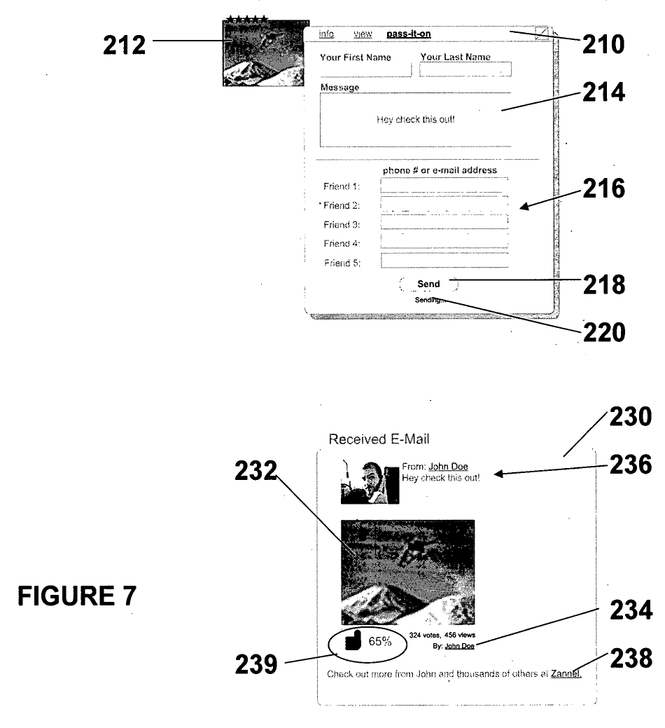

FIG. 7 illustrates an example of the pass it on application user interface on the sender and receiver side. In the examples shown below, an image piece of content is being shared using the content sharing system. However, the content sharing system may be used to share other types of content including games, videos and video clips. A user interface 210 that appears on the sender computing device when the user wants to use the pass it on method to share a piece of content that is shown as a thumbnail 212. As shown, the pass in on user interface permits the user who is sending the content to enter the name of the sending user, a personal message 214 to each friend who is going to receive the pass it on message and one or more addresses 216 (email addresses or phone numbers) of a predetermined maximum users, 5 users in this example, to which the content is being shared. When the user is ready to share the content, the user may press a send button 218. When the user hits the send button, a status field 220 shows the status “Sending . . . ” and then changes to “Sent” when the sharing is complete. When the sending is completed, the destinations fields 216 are cleared. A user interface of a message 230 received by a receiving user is shown. The message 230 contains a thumbnail 232 and the user can click on the thumbnail to go to the content sharing site to see the full content (an image in this example). The message may further include an author link 234, a sender link 236, a content sharing system link 238 and a rating 239 of the content being shared. If the user clicks on the author link 234, the user goes to (using a browser application on the device) the content channel of the content author or if the user clicks on sender content/name 236, the user goes to (using a browser application on the device) the content channel of the content sender who also happens to be the content author in this example. If the user clicks on the system link 238, the user goes to (using a browser application on the device) the content sharing system site.

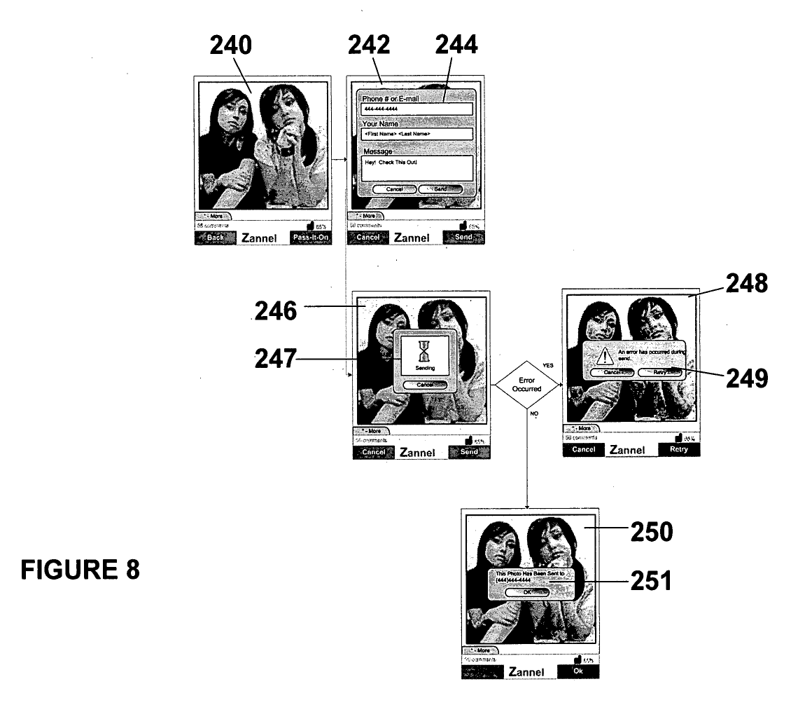

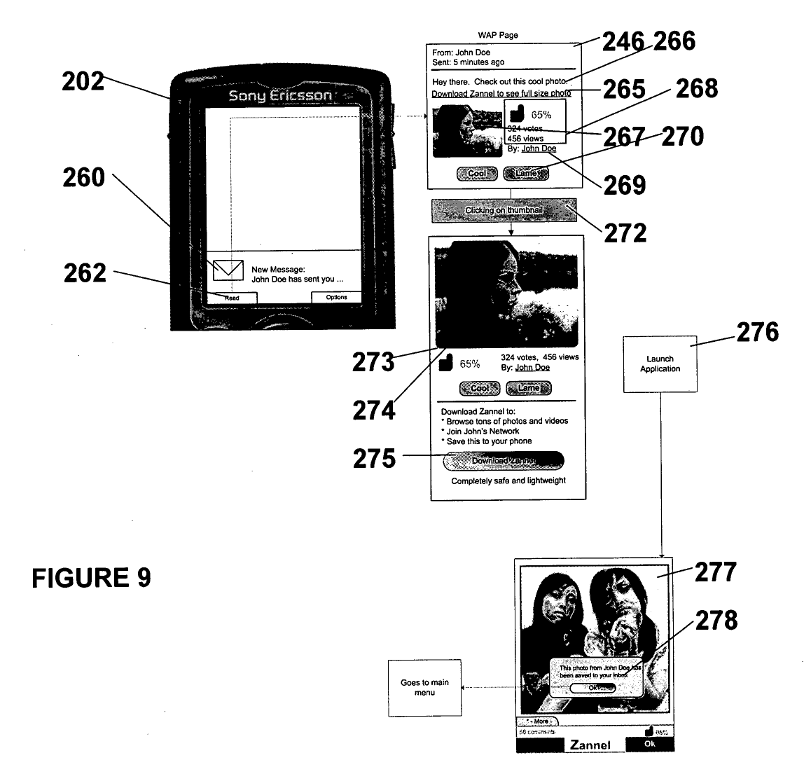

FIG. 8 illustrates an example of the user interface at the pass it on sender device during the sending of content. In the user interfaces shown in FIGS. 8 and 9, the user can navigate through the fields and buttons using the left/right or up/down buttons of the computing device. A user interface 240 is shown when a sender device (executing the content sharing application) views a piece of content, a photo in this example. The user interface 240 has a back button to return to the previous user interface screen of the application and a pass-it-on button to go to a pass-it-on screen for sharing the content. When the user clicks on the pass-it-on button (242), the pass-it-on user interface 244 is shown to the user so that the user can fill in fields for sharing the content and then click on the send button to send the message with a thumbnail of the content and the wrapper application. The user can fill in the phone number/email address. The “your name” field may be automatically filled in and the message field is initially filled in with a default personal message which the user can modify. While the content is being sent (246) a sending message 247 is shown to the user. The user interface may include animated graphics (a flying pig) while the user waits, advertising while the user waits, a tip of the day while the user waits, humor of the day while the user waits or a pong game while the user waits instead of the sending message 247. If an error during the sending of the content occurs, then a user interface 248 is shown with an error message 249. The user interface may provide more information about the error such as the carrier not being supported, the phone not being supported or a recommendation with other content. If an error did not occur, a user interface 250 is displayed along with a message 251 indicating that the content was successfully sent. If the phone number shown in the message 251 belongs to a registered content sharing user, the phone number is replaced by the username.

FIG. 9 illustrates an example of the user interface at the pass it on receiving computing device during receiving of content. The receiving computing device 202 shows a new message indicator 260 when the user receives a new content sharing message. The user may click on a read button 262 (or soft button) to read the message and is shown a WAP page 264 if it is supported by the receiving computing device. If the WAP page is not supported by the receiving computing device, the thumbnail/preview is shown and the user is asked to enter an email address to send the content to the user. The WAP page may include a link 265 to download the wrapper application to view the full size content and a personal message 266. The message includes a thumbnail 267, the ratings 268 of the content and an author link 269. The message may include a set of rating buttons 270 to rate the content. When the user clicks on the thumbnail (272), a user interface 273 is shown that includes the full content 274 which also includes a link 275 to download the wrapper application for the particular model of receiving computing device. When the user clicks on the link 275, the application is downloaded and the application is launched (276). When the wrapper application is launched, a user interface 277 is shown that also displays the inbox message 278.

While the foregoing has been with reference to a particular embodiment of the invention, it will be appreciated by those skilled in the art that changes in this embodiment may be made without departing from the principles and spirit of the invention, the scope of which is defined by the appended claims.

1. A method for sharing content between a sending computing device and a receiving computing device using a sharing unit that is capable of communicating with the computing devices, the method comprising:
generating, at the sending computing device, a content sharing message containing a title of the content, an address of the receiving computing device and a personal message to a user of the receiving computing device;
associating a user identification for the receiving computing device with the number of the receiving computing device;
sending a message, formatted to a carrier associated with the receiving computing device, that contains a reference to the content and a wrapper application; and
invoking the application download process on the receiving computing device to share the content with the receiving computing device using the application executed by the receiving computer device.

2. The method of claim 1, wherein associating a user identification for the receiving computing device with the number of the receiving computing device further comprises verifying the number of the receiving computing device and creating a new user of the system based on the number of the receiving computing device.

3. The method of claim 1, wherein invoking the application download process further comprises generating, at the receiving computing device, a response message containing a header, identifying the receiving computing device model from the header of the response message generated by clicking a link on the sending message, and associating the sender message with a specific version of the wrapper application and the content.

4. The method of claim 1, wherein sending the message further comprises sending an short message service message.

5. The method of claim 1, wherein the address for the application further comprises a dynamically generated uniform resource locator for a WAP site referencing a specific version of the content compatible with the receiving computing device.

6. The method of claim 5, wherein invoking the URL on the receiving computing device further comprises detecting a model of the receiving computing device and delivering the wrapper application and content to the receiving computing device based on the model of the receiving computing device.

7. The method of claim 6, wherein delivering the content to the receiving computing device further comprises delivering an email message with a dynamically generated uniform resource location for the content to the receiving computing device when the receiving computing device does not support available application formats and does not support a WAP protocol.

8. The method of claim 6, wherein delivering the content to the receiving computing device further comprises delivering a WAP protocol page with a link to the correctly formatted content to the receiving computing device when the receiving computing device supports only the WAP protocol.

9. The method of claim 6, wherein delivering the content to the receiving computing device further comprises delivering a WAP summary page with a link to download a specific version of a mobile client application when the receiving computing device supports both the WAP protocol and any supported application format.

10. The method of claim 1, wherein the content further comprises an image, a game, a video or a video clip.

11. A system for sharing content between a sending computing device and a receiving computing device capable of communicating with the computing devices, the system comprising:
a receiving computing device and a sending computing device that are capable of coupling to a content sharing unit;
the content sharing unit comprising a plurality of pieces of content and one or more wrapper applications wherein each wrapper application operates for a particular model of the receiving computing device;
the sending computing device further comprises a content sharing application that is configured to generate a content sharing message containing a title of the content, an address of the receiving computing device and a personal message to a user of the receiving computing device and the content sharing application is configured to send the message, formatted to a carrier associated with the receiving computing device, that contains a reference to the content and a wrapper application; and
the receiving computing device further comprises a unit for invoking an application download process to share the content with the receiving computing device using the application executed by the receiving computer device.

12. The system of claim 11, wherein the content sharing unit further comprises a user service that verifies the number of the receiving computing device and creates a new user of the system based on the number of the receiving computing device.

13. The system of claim 11, wherein the unit for invoking an application download process further comprises a unit that is configured to generate a response message containing a header and wherein the content sharing unit further comprises a device profile engine that is configured to identify the receiving computing device model from the header of the response message and select a specific version of the wrapper application.

14. The system of claim 11, wherein content sharing message further comprises an short message service message.

15. The system of claim 11, wherein the address for the application further comprises a dynamically generated uniform resource locator for a WAP site referencing a specific version of the content compatible with the receiving computing device.

16. The system of claim 15, wherein the content sharing unit further comprises a device profile engine that is configured to deliver the wrapper application and content to the receiving computing device based on the model of the receiving computing device.

17. The system of claim 11, wherein the content further comprises an image, a game, a video or a video clip.

18. The system of claim 11, wherein each computing device further comprises one of a processing unit based device with memory and connectivity to interact with the content sharing unit, a mobile phone, a cellular phone, a wireless email device, a combined email/phone device, a web browser application on the mobile device or a PDA.
